(19) United States
(12) Patent Application Publication
(10) Pub. No.: US 2025/0321720 A1
(43) Pub. Date: Oct. 16, 2025

(54) VISUAL PROGRAMMING METHOD, ELECTRONIC DEVICE, STORAGE MEDIUM, AND PROGRAM PRODUCT

(71) Applicants: Beijing Zitiao Network Technology Co., Ltd., Beijing (CN); Lemon Inc., Cayman Islands (KY)

(72) Inventors: Jingbin HUANG, Beijing (CN); Runze ZHANG, Los Angeles, CA (US); Weifeng HUANG, Beijing (CN)

(21) Appl. No.: 18/990,690

(22) Filed: Dec. 20, 2024

(30) Foreign Application Priority Data
Apr. 12, 2024 (CN) 202410448110.8

(51) Int. Cl. G06F 8/34; G06F 8/41

(52) U.S. Cl. CPC G06F 8/34; G06F 8/427

(57) ABSTRACT

Embodiments of the present disclosure provide a visual programming method, an electronic device, a storage medium, and a program product. The visual programming method includes: displaying a visual programming interface, where the visual programming interface includes a first programming element and a second programming element that are presented in a first state; and in the first state, attribute data of the first programming element and the second programming element is obtained by instantiating a first resource; and updating the first resource in response to a first editing trigger operation input for the attribute data of the first programming element, so as to update the attribute data of the first programming element and the second programming element.

### CROSS-REFERENCE TO RELATED APPLICATION

The present application claims priority of the Chinese Patent Application No. 202410448110.8, filed on Apr. 12, 2024, the disclosure of which is incorporated herein by reference in its entirety as part of the present application.

### TECHNICAL FIELD

Embodiments of the present disclosure relate to a visual programming method, an electronic device, a storage medium, and a program product.

### BACKGROUND

Visual programming provides a visual way to design programming logic, and is widely used in fields such as education, gaming, and special effect editing. In a process of visual programming, many programming elements often need to be created, including programming elements created by using the same resource. However, during editing of programming elements, only one programming element can be operated at a time, which leads to low efficiency of visual programming, or even repetitive editing operations, thereby affecting programming experience of a user.

### SUMMARY

The embodiment of the present disclosure provides a visual programming method. The method includes:
displaying a visual programming interface, where the visual programming interface includes a first programming element and a second programming element that are presented in a first state; and in the first state, attribute data of the first programming element and the second programming element is obtained by instantiating a first resource; and
updating the first resource in response to a first editing trigger operation input for the attribute data of the first programming element, so as to update the attribute data of the first programming element and the second programming element.

The embodiment of the present disclosure further provides a visual programming apparatus. The apparatus includes a programming interface display module and an element linkage editing module.

The programming interface display module is configured to display a visual programming interface, where the visual programming interface includes a first programming element and a second programming element that are presented in a first state; and in the first state, attribute data of the first programming element and the second programming element is obtained by instantiating a first resource.

The element linkage editing module is configured to update the first resource in response to a first editing trigger operation input for the attribute data of the first programming element, so as to update the attribute data of the first programming element and the second programming element.

The embodiment of the present disclosure further provides an electronic device. The electronic device includes one or more processors and a memory. The memory is configured to store one or more programs. When the one or more programs are executed by the one or more processors, the one or more processors is caused to implement the visual programming method according to any one of the embodiments of the present disclosure.

The embodiment of the present disclosure further provides a storage medium including computer-executable instructions. When the computer-executable instructions are executed by a computer processor, the computer-executable instructions are used to perform the visual programming method according to any one of the embodiments of the present disclosure.

The embodiment of the present disclosure further provides a computer program product. The computer program product includes a computer program that, when the computer program is executed by a processor, the processor is caused to implement the visual programming method according to any one of the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1A is a schematic flowchart of a visual programming method according to an embodiment of the present disclosure;

FIG. 1B is a schematic diagram of a local area of a visual programming interface that may be used for a visual programming method provided in an embodiment of the present disclosure, according to an embodiment of the present disclosure;

FIG. 1C is a schematic diagram of a tree architecture of a visualized script that is created by using a visual programming method provided in an embodiment of the present disclosure, according to an embodiment of the present disclosure;

FIG. 1D is a schematic diagram of an architecture of a subtree corresponding to programming elements that are presented in a first state in FIG. 1C according to an embodiment of the present disclosure;

FIG. 2 is a schematic flowchart of another visual programming method according to an embodiment of the present disclosure;

FIG. 3A is a schematic flowchart of another visual programming method according to an embodiment of the present disclosure;

FIG. 3B is a structural schematic diagram of elements to be parsed before parsing, which may be used for a visual programming method provided in an embodiment of the present disclosure, according to an embodiment of the present disclosure;

FIG. 3C is a structural schematic diagram of elements to be parsed after parsing in a first state, which may be used for a visual programming method provided in an embodiment of the present disclosure, according to an embodiment of the present disclosure;

FIG. 3D is a structural schematic diagram of elements to be parsed after parsing in a second state, which may be used for a visual programming method provided in an embodiment of the present disclosure, according to an embodiment of the present disclosure;

FIG. 4A is a schematic flowchart of another visual programming method according to an embodiment of the present disclosure;

FIG. 4B is a structural schematic diagram of a creation path record map of programming elements that may be used for a visual programming method provided in an embodiment of the present disclosure, according to an embodiment of the present disclosure;

FIG. 5 is a structural schematic diagram of a visual programming apparatus according to an embodiment of the present disclosure; and

FIG. 6 is a structural schematic diagram of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

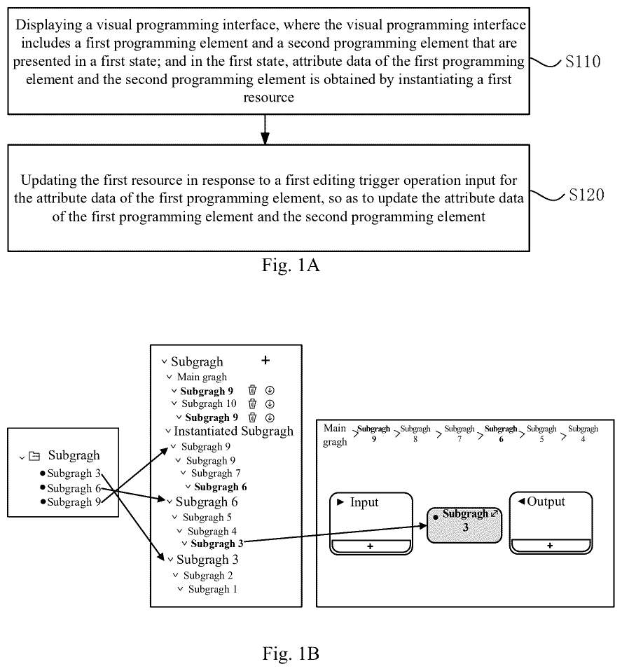

FIG. 1A is a schematic flowchart of a visual programming method according to an embodiment of the present disclosure. This embodiment of the present disclosure is applicable to a case that programming elements are edited in a visual programming scenario, and the method may be performed by a visual programming apparatus. The apparatus may be implemented in the form of software and/or hardware. Optionally, the apparatus may be implemented by an electronic device, and the electronic device may be a mobile terminal, a PC terminal, a server, or the like.

As shown in FIG. 1A, the method in this embodiment may specifically include the following steps.
S110: displaying a visual programming interface, where the visual programming interface includes a first programming element and a second programming element that are presented in a first state; and in the first state, attribute data of the first programming element and the second programming element is obtained by instantiating a first resource.

In this embodiment of the present disclosure, the visual programming interface can be understood as an operation interface that is used for inputting a programming operation and that may generate a script file based on the programming operation. The visual programming interface may be used to provide a resource needed for programming. The visual programming interface may be a programming interface that is used to design and implement content such as game logic, character behavior, a level design, and an interactive interface.

For example, the visual programming interface may include a plurality of areas, and different areas may be used to display different types of programming resources. For example, display content of the visual programming interface may include, but is not limited to, at least one of the following content: at least a partial area of a canvas for drawing programming elements, which may be displayed in a first area of the visual programming interface; a resource for editing (for example, adding or deleting) programming elements in the canvas, which may be displayed in a second area of the visual programming interface; relationship navigating information between programming elements that have been created and a plurality of programming elements, which is displayed in a third area of the visual programming interface; and identifiers of programming elements of preset types, which are displayed in a fourth area of the visual programming interface, and the like.

Optionally, the visual programming interface may be a graphical programming interface. A programming element may be a subgraph. In the graphical programming interface, programming can be implemented by editing graphical programming elements in the visual programming interface, with no need to manually write complex code, so that more users can participate in programming.

As an optional implementation solution of this embodiment of the present disclosure, a navigation bar may have two categories, programming elements and programming elements in a first state, and the programming elements in the first state are displayed separately. For ease of understanding, taking subgraphs in graphical programming as an example, as shown in FIG. 1B, the visual programming interface may include a resource panel (left frame in FIG. 1B) that is used for displaying resource identifiers of subgraph resources of subgraphs (instantiated subgraphs) in the first state, so as to quickly locate the subgraph resources of the instantiated subgraphs. A navigation bar (a middle frame in FIG. 1B) has two categories, subgraphs and instantiated subgraphs. The division into the two categories helps clearly display the structure of graphical programming. In the case of actual displaying the instantiated subgraphs in each category, the navigation bar does not continue to expand downward to avoid repeated display when a plurality of layers of nested instantiated subgraphs exist.

A programming element can be understood as an element that may be used as a programming node in visual programming. Logic of visual programming is encapsulated in a programming element. There may be a plurality of types of programming elements. The programming elements are used to divide complex logic or functions into smaller and more manageable parts to improve readability, maintainability, and reusability. Optionally, the programming element may be obtained by combining a plurality of associated operations (subelements). An advantage of such configuration is that the operation complexity of the overall visual programming can be reduced, and the same logic does not need to be repeatedly constructed when the programming elements need to be reused. When there are too many programming nodes and connection lines needing to be drawn in the visual programming interface, the burden of interface drawing is significantly increased, resulting in a stuck interface. Moreover, more complex logic of visual programming indicates more programming nodes and connection lines, and higher difficulty in troubleshooting and maintenance. In this case, using programming elements to encapsulate the logic of visual programming can greatly reduce the number of nodes in the visual programming interface, simplify the understanding of visual programming and reduce costs of troubleshooting.

The attribute data of the programming element may be understood as internal logical data of the programming element or internal structured data of the programming element. For example, the attribute data includes at least one of an element type, an element identifier, a port identifier of an element port, an internal variable, data of included subelements, and connection line data between the subelements, and other data of the first programming element and the second programming element.

In the first state, the programming elements store only element ports and connection line data of the element ports, and point to a target resource corresponding to the programming elements. For a plurality of programming elements in the first state, element ports of the programming elements and connection line data of the element ports are unique to the programming elements themselves, but data stored on a target resource, such as internal variables of the programming elements, data of included subelements, and connection line data between the subelements, is common to the plurality of programming elements.

It can be understood that there may be one or more programming elements created in the visual programming interface. When the visual programming interface includes a plurality of programming elements, there may be a nesting relationship between the plurality of programming elements. To be specific, programming elements corresponding to a resource store programming elements corresponding to another resource in an instantiated state, so that there may be multiple nesting between the resources. For example, the visual programming interface includes a fourth programming element; and a fifth programming element is nested in the fourth programming element, and attribute data of the fifth programming element is obtained by instantiating a second resource.

In order to facilitate an understanding of a relationship between the programming elements and a target resource, subgraphs and subgraph resources in a visualized programming scenario are taken as an example for illustration. A subgraph in the first state is referred to as an instantiated subgraph for short. As shown in FIG. 1C and FIG. 1D, a main graph 10 of visual programming may be regarded as a tree, including a subgraph 11, a subgraph 12, a subgraph 13, and a subgraph 14. The graph 11 is presented in a second state; and the subgraph 12, the subgraph 13, and the subgraph 14 are presented in the first state and are instantiated subgraphs. Because subgraphs may be nested, internal data of each subgraph resource may be regarded as a subtree. As shown in FIG. 1D, a subtree of the subgraph 14 is provided in a left frame and is nested with the instantiated subgraph 13, and a subtree of the subgraph 14 corresponds to a subgraph resource 101. When the instantiated subgraph is used, actually, the subtree of the subgraph resource is temporarily spliced into the main graph (shown by a dashed-line box in the figure). Benefits of such an arrangement are that programming elements of the visual programming interface can support more complex logic and performance consumption is reduced.

As an optional technical solution of this embodiment of the present disclosure, after the visual programming interface is displayed, a first programming element and a second programming element may be created in the visual programming interface. Specifically, in response to multiple element addition trigger operations input for preset programming elements, a plurality of preset programming elements may be added to the visual programming interface to obtain a first programming element and a second programming element; and/or, in response to an element addition trigger operation input for a preset programming element, the first programming element is created in the visual programming interface based on a target resource of the preset programming element, and in response to a copy-and-paste trigger operation for the first programming element, the second programming element is created in the visual programming interface. With the above technical solution, the first programming element and the second programming element can be created in the visual programming interface simply, quickly, and conveniently.

For example, a preset programming element may be dragged into the visual programming interface to obtain a first programming element, or preset programming elements may be selected and a preset add button is triggered to add a plurality of preset programming elements to the visual programming interface to obtain the first programming element, and then the preset programming elements may be added to the visual programming interface again to obtain the second programming element. Alternatively, a copy-and-paste operation is performed on the first programming element in the visual programming interface to obtain the second programming element.

In order to quickly determine the first programming element and the second programming element from a visual degree, the first programming element and the second programming element may use the same element identifier, or element identifiers of the first programming element and the second programming element both carry preset content.
S120: updating the first resource in response to a first editing trigger operation input for the attribute data of the first programming element, so as to update the attribute data of the first programming element and the second programming element.

In the first state, subelements of the programming elements are obtained by instantiating the target resource. Since internal variables, data of included subelements, connection line data between the subelements of the programming elements, and the like are stored in the first resource, the editing of the internal variables, the data of the included subelements, and the connection line data between the subelements of the programming elements is actually equivalent to directly editing data of the target resource, and the programming elements can be automatically updated without requiring additional data synchronization. However, element ports of the programming elements and connection line data of the element ports are unique to the programming elements. When element types of the programming elements, element identifiers of the programming elements or port identifiers of the element ports are determined, a message is sent for synchronization to all the associated programming elements. The input and/or output of the instantiated programming elements in the first state may be different, but internal content is the same.

As an optional implementation of this embodiment of the present disclosure, after displaying a visual programming interface, the method may further include: updating input data and/or output data of the first programming element in response to a second editing trigger operation input for the first programming element. The input data and/or the output data is associated with an element port of the first programming element and connection line data of the element port. In a visual programming scenario, a plurality of programming elements often exist, and a connection relationship between the programming elements is closely related to functions of the programming elements in a program and overall logic of the program. With this technical solution, the input data and/or the output data of the first programming element may be edited independently, thereby implementing differentiated editing of different data of the first programming element.

The first editing trigger operation can be understood as an operation for editing the input data and/or the output data of the first programming element. For example, the first editing trigger operation may be at least one of operations of modifying a connection object connected to the first programming element, modifying an element port connected to the connection object, deleting or creating a connection, deleting an element port, etc.

As an optional implementation of this embodiment of the present disclosure, after displaying a visual programming interface, the method may further include: displaying, for a third programming element in a visible state in the visual programming interface, a creation path of the third programming element in the visual programming interface. With this technical solution, the position of the third programming element in a programming link can be visually and conveniently understood.

Being in a visible state can be understood as a state of being currently displayed in a programming window of the visual programming interface. The creation path is used to show a specific position of the third programming element in the entire programming link or on a branch in the programming link. The creation path may include element identifiers of the third programming element and the associated programming element of the third programming element, and a plurality of element identifiers are arranged based on a nesting relationship between the third programming element and the associated programming element. Further, a presentation state of each of the programming elements (the third programming element and the associated programming element) included in the creation path may be determined respectively, and then the element identifiers of the programming elements are displayed in the creation path based on the presentation states of the programming elements.

Reference is still made to FIG. 1B. A programming window (a right frame in FIG. 1B) is displayed in the graphical programming interface, and a creation path of a currently displayed third programming element (subgraph 3) is provided at an upper left corner of the programming window, that is, a main graph>a subgraph 9>a subgraph 8>a subgraph 7>a subgraph 6>a subgraph 5>a subgraph 4. Instantiated subgraphs (the subgraph 9 and the subgraph 6) are distinguished from subgraphs in other presentation states by blue, so that a user can clearly understand current subgraph positioning.

According to the technical solutions of this embodiment of the present disclosure, firstly, the visual programming interface is displayed for programming interaction. Since the visual programming interface includes the first programming element and the second programming element that are presented in the first state, and in the first state, the attribute data of the first programming element and the second programming element is obtained by instantiating the first resource, that is, the first programming element and the second programming element can be presented in an instantiated state, thereby enriching a presentation state of programming elements in the visual programming interface. Then, since the first programming element and the second programming element correspond to the same resource (first resource), the first resource is updated in response to the first editing trigger operation input for the attribute data of the first programming element, so that the attribute data of the first programming element and the second programming element can be updated in batches, thereby solving the technical problem of low programming efficiency caused by the need to edit programming elements one by one, improving efficiency of visual programming, and improving visual programming experience of a user.

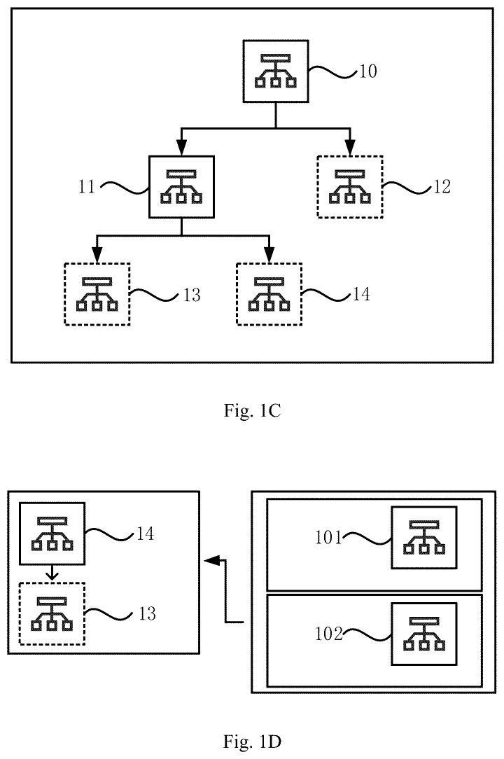

FIG. 2 is a schematic flowchart of another visual programming method according to an embodiment of the present disclosure. On the basis of the above embodiment, the technical solution of this embodiment adds the technical feature that the first programming element and/or the second programming element can perform state switching. Optionally, after displaying a visual programming interface, the method further includes: switching the first programming element and/or the second programming element from the first state to a second state in response to a state switching trigger operation for the first programming element and/or the second programming element, where in the second state, the attribute data of the first programming element and the second programming element is element private data. For a specific implementation, reference may be made to the description of this embodiment. Details about technical features that are the same as or similar to those in the foregoing embodiment are not repeated herein.

As shown in FIG. 2, the method in this embodiment may specifically include the following steps.
S210: displaying a visual programming interface, where the visual programming interface includes a first programming element and a second programming element that are presented in a first state; and in the first state, attribute data of the first programming element and the second programming element is obtained by instantiating a first resource.
S220: updating the first resource in response to a first editing trigger operation input for the attribute data of the first programming element, so as to update the attribute data of the first programming element and the second programming element.
S230: switching the first programming element and/or the second programming element from the first state to a second state in response to a state switching trigger operation for the first programming element and/or the second programming element.

The state switching trigger operation can be understood as an operation for triggering the switching of a presentation state of one or more programming elements that have been created in the visual programming interface. The state switching trigger operation may be generated by applying to a preset state switching control, or generated based on a preset trigger action (such as a gesture or audio), which is not specifically limited herein.

In this embodiment of the present disclosure, in the second state, the attribute data of the first programming element and the second programming element may be converted into element private data. After switching the first programming element and/or the second programming element from the first state to the second state, the method further includes: determining a target programming element in the second state, acquiring attribute data corresponding to the target programming element, converting the attribute data into element private data of the target programming element, and storing the element private data corresponding to the target programming element. This is equivalent to copying content of a target resource corresponding to the target programming element. Further, in the second state, the element private data of the target programming element is edited in response to an editing trigger operation for the target programming element. For example, in the second state, only private data of the first programming element is edited in response to an editing trigger operation for the first programming element, and no matter whether the second programming element is in the first state or the second state, the edited content of the first programming element is not synchronized to the second programming element.

It should be noted that when the programming elements are being parsed, in response to there are different programming elements that correspond to the same resource and that are all in the first state, although internal variables of the different programming elements have the same initial value and data, each programming element is a different individual during actual parsing and use. This ensures that logic of the programming elements in the first state is the same as that of the programming elements after the programming elements are all switched to the second state.

In order to facilitate distinguishing the states of programming elements, programming elements in different presentation states and element identifiers of the programming elements in different presentation states may be displayed differentially. For example, the programming elements in different presentation states and the element identifiers of the programming elements in different presentation states may be presented in different colors. For example, a programming element in the first state and an element identifier of the programming element in the first state may be presented in a first color, and a programming element in the second state and an element identifier of the programming element in the second state may be presented in a second color.

According to the technical solution of this embodiment of the present disclosure, in response to the state switching trigger operation for the first programming element and/or the second programming element, an interactive manner that may be adopted during switching of the states of the first programming element and/or the second programming element is enriched, and operation flexibility of state switching is improved. The first programming element and/or the second programming element is switched from the first state to the second state, which increases presentation states of the first programming element and/or the second programming element, and implements flexible switching of the first programming element and/or the second programming element between different presentation states.

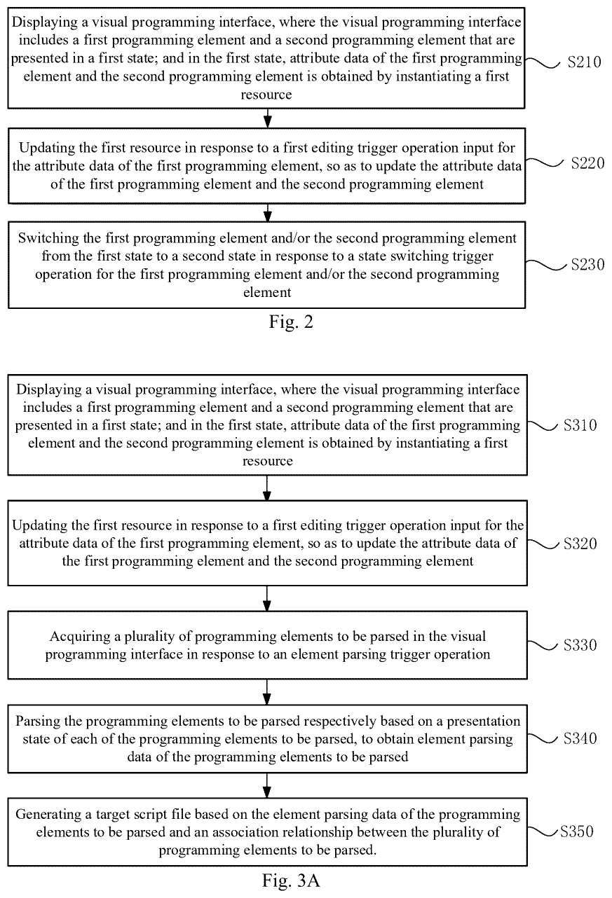

FIG. 3A is a schematic flowchart of another visual programming method according to an embodiment of the present disclosure. On the basis of the above embodiment, the technical solution of this embodiment adds the technical features of parsing programming elements and a manner of generating a target script file. Optionally, after displaying a visual programming interface, the method further includes: acquiring a plurality of programming elements to be parsed in the visual programming interface in response to an element parsing trigger operation; parsing the programming elements to be parsed respectively based on a presentation state of each of the programming elements to be parsed, to obtain element parsing data of the programming elements to be parsed, where the presentation state includes at least the first state; and generating a target script file based on the element parsing data of the programming elements to be parsed and an association relationship between the plurality of programming elements to be parsed. For a specific implementation, reference may be made to the description of this embodiment. Details about technical features that are the same as or similar to those in the foregoing embodiment are not repeated herein.

As shown in FIG. 3A, the method in this embodiment may specifically include the following steps.
S310: displaying a visual programming interface, where the visual programming interface includes a first programming element and a second programming element that are presented in a first state; and in the first state, attribute data of the first programming element and the second programming element is obtained by instantiating a first resource.
S320: updating the first resource in response to a first editing trigger operation input for the attribute data of the first programming element, so as to update the attribute data of the first programming element and the second programming element.
S330: acquiring a plurality of programming elements to be parsed in the visual programming interface in response to an element parsing trigger operation.

The element parsing trigger operation can be understood as an operation of parsing the programming elements in the visual programming interface after being triggered. For example, the element parsing operation may be a control trigger operation applied to a preset parsing trigger control, an operation of inputting a preset parsing trigger gesture or parsing trigger audio, or the like.

In this embodiment of the present disclosure, the plurality of programming elements to be parsed in the visual programming interface may be all programming elements that have been created in the visual programming interface, or some programming elements that have been created in the visual programming interface.

Optionally, acquiring a plurality of programming elements to be parsed in the visual programming interface, includes: acquiring the plurality of programming elements to be parsed from a plurality of programming elements that have been created in the visual programming interface based on a preset screening rule; and/or receiving an element selection operation input for the plurality of programming elements that have been created in the visual programming interface, and acquiring the plurality of programming elements to be parsed from the plurality of programming elements that have been created based on the element selection operation, etc.
S340: parsing the programming elements to be parsed respectively based on a presentation state of each of the programming elements to be parsed, to obtain element parsing data of the programming elements to be parsed.

Visual programming generally needs to be parsed into practically executable script code for use, and the complexity of the parsed code is one of indexes of visual programming optimization. In order to reduce the overhead and memory occupation of code running of the programming elements to be parsed, in this embodiment of the present disclosure, the programming elements are classified into different presentation states. The same or different parsing manners may be used for the programming elements to be parsed in different presentation states. The presentation state may include the first state and the second state. In the second state, the programming elements are not reusable. When the programming elements that are not reused are parsed, the programming elements that are not reused have no actual programming element structure, and are directly expanded. When the programming elements in the first state are parsed, the programming elements in the first state retain the structure of the programming elements for code reuse.

To sum up, when the programming elements to be parsed are presented in the first state, the element parsing data is obtained by instantiating a target resource of the programming elements to be parsed; and/or, when the programming elements to be parsed are presented in a second state, the programming elements to be parsed are expanded to obtain the element parsing data of the programming elements to be parsed.

FIG. 3B is a structural schematic diagram of elements to be parsed before parsing, which may be used for a visual programming method provided in an embodiment of the present disclosure, according to an embodiment of the present disclosure. As can be seen from FIG. 3B, an element 30 to be parsed includes four ports, namely, an input port 31, an input port 32, an output port 33, and an output port 34. Essential content of the element 30 to be parsed is element parsing data (code segment) 301. Input data of the input port 31 and the input port 32 may be determined according to actual requirements, such as an interactive operation or updating data, which is not specifically limited herein. Output data of the output port 33 and the output port 34 may be determined according to actual requirements, such as determining data or function values, which is not specifically limited herein.

As for parsing of the programming elements to be parsed that are presented in the first state, as shown in FIG. 3C, a programming element class is constructed for a target resource of the programming elements to be parsed, and using the programming elements to be parsed that are presented in the first state is equivalent to creating a programming element object 30 from the programming element class, which has the advantage that the cost is lower when a plurality of instantiated programming elements to be parsed are reused. As for parsing the programming elements to be parsed that are presented in the second state, as shown in FIG. 3D, the programming elements to be parsed themselves do not need to be reused, so that the structure of the programming elements to be parsed is not retained, and an form of the programming elements to be parsed after being expanded is adopted on the whole for parsing to obtain element parsing data (code segment) 301, without parsing a relationship between each port and each port of the element parsing data (code segment) 301, which is relatively lightweight.
S350: generating a target script file based on the element parsing data of the programming elements to be parsed and an association relationship between the plurality of programming elements to be parsed.

The association relationship between the plurality of programming elements to be parsed includes at least a connection relationship and/or a nesting relationship, etc.

For example, a logical structure between the plurality of programming elements to be parsed may be constructed based on the association relationship between the plurality of programming elements to be parsed, and the element parsing data may be organized based on the logical structure to ensure correctness and integrity of the data. The data after being organized is converted into a syntax rule of a target script language, and a script syntax after conversion is typeset and formatted based on format requirements of the target script file to generate a final target script file. Further, after the target script file is generated, at least one of harness operations may be further performed: displaying the target script file and displaying a file identifier of the target script file; storing the target script file in a target storage space; sending the target script file to a target platform; and so on.

According to the technical solution of this embodiment of the present disclosure, the plurality of programming elements to be parsed in the visual programming interface are obtained in response to the element parsing trigger operation, which can accurately determine the programming elements that need to be parsed to generate the target script file, and avoid performing unnecessary parsing operations. Then, the programming elements to be parsed are parsed respectively based on a presentation state of each of the programming elements to be parsed, to obtain element parsing data of the programming elements to be parsed, which can flexibly parse the programming elements to be parsed in different manners to reduce performance pressure caused by performing parsing operations. Finally, the target script file is automatically generated based on the association relationship between the plurality of programming elements to be parsed and the element parsing data of the programming elements to be parsed. This reduces the programming difficulty, lowers an editing threshold of visual programming, broadens the application scope of visual programming, and improves operating experience of visual programming.

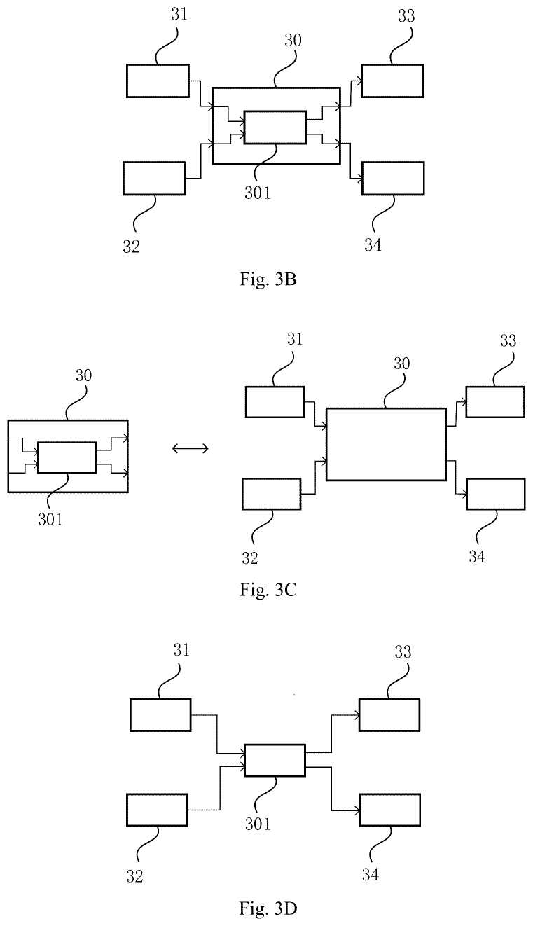

FIG. 4A is a schematic flowchart of another visual programming method according to an embodiment of the present disclosure. On the basis of the above embodiment, the technical solution of this embodiment adds the technical features of parsing programming elements and a manner of generating a target script file. Optionally, the visual programming interface includes a navigation bar, and the navigation bar is used to display element identifiers of programming elements that have been created in the visual programming interface; a presentation mode of a plurality of the element identifiers in the navigation bar is associated with a presentation state of the programming elements; and the presentation state includes at least the first state. Further, after displaying a visual programming interface, the method may further include: in response to an identifier trigger operation applied to the element identifiers in the navigation bar, determining the programming elements displayed in the visual programming interface as initial programming elements, and searching for a target programming element corresponding to the element identifiers level by level based on a creation path of the initial programming elements in the visual programming interface. For a specific implementation, reference may be made to the description of this embodiment. Details about technical features that are the same as or similar to those in the foregoing embodiment are not repeated herein.

As shown in FIG. 4A, the method in this embodiment may specifically include the following steps.
S410: displaying a visual programming interface, where the visual programming interface includes a first programming element and a second programming element that are presented in a first state; and in the first state, attribute data of the first programming element and the second programming element is obtained by instantiating a first resource; and the visual programming interface includes a navigation bar, and the navigation bar is used to display element identifiers of programming elements that have been created in the visual programming interface.

In this embodiment of the present disclosure, the navigation bar of the visual programming interface displays the element identifiers of the programming elements that have been created in the visual programming interface, so that centralized management and quick positioning for the element identifiers of the programming elements that have been created in the visual programming interface can be implemented. Optionally, a presentation mode of a plurality of element identifiers in the navigation bar is associated with a presentation state of the programming elements. The presentation state is associated with an editing operation supported or prohibited by the programming elements. The presentation state includes at least the first state. The presentation state may further include the second state.
S420: updating the first resource in response to a first editing trigger operation input for the attribute data of the first programming element, so as to update the attribute data of the first programming element and the second programming element.
S430: in response to an identifier trigger operation applied to the element identifiers in the navigation bar, determining the programming elements displayed in the visual programming interface as initial programming elements, and searching for a target programming element corresponding to the element identifiers level by level based on a creation path of the initial programming elements in the visual programming interface.

In this embodiment of the present disclosure, when the identifier trigger operation for the element identifiers in the navigation bar is received, the target programming element corresponding to the element identifiers is navigated to based on a preset navigation manner. Optionally, based on the creation path of the initial programming elements in the visual programming interface, lower-level nodes of the initial programming elements are first searched, and in response to no target programming element corresponding to the element identifiers being found, an upper-level root node of the initial programming elements is updated to the initial programming elements, and searching of lower-level nodes of the initial programming elements continues. In response to no target programming element being found, the operation of updating the upper-level root node of the initial programming elements to the initial programming elements is performed again. The searching is stopped when all the programming elements are searched, or when the target programming element corresponding to the element identifiers is found.

For example, when an identifier trigger operation for the element identifiers in the navigation bar, such as an operation of tapping the element identifiers, is received, corresponding subgraphs are searched for downward from currently displayed programming elements in the visual programming interface. In response to no programming element being found by current positioning in the visual programming interface, related programming elements are searched for based on a root node where the current positioning is located (which may be a root node (root node corresponding to a script) of the entire programming link or a root node of a subtree in the programming link). In response to still no programming element being found, node searching is performed based on an upper-level root node of the current root node, and so on, until the root node searched is the root node of the entire programming link.

Optionally, in response to an element viewing trigger operation input for the programming elements, an element item to which the element viewing trigger operation is applied is determined, a target programming element to be viewed is determined based on the applied element item, and the target programming element is displayed. Each element item of the programming elements corresponds to one of the programming elements.

Optionally, when an interior of a programming element in the first state in the visual programming interface is entered, refresh of a data stream of a port in the programming element can be seen. Considering that programming elements may be nested, nested programming elements need to be positioned during use. When an interior of a programming element presented in the first state is entered for editing, since there is only one piece of data at this time, the positioning of the programming element that is presented in the first state needs to be known before the subgraph code can be parsed and the port interaction data can be updated. Therefore, a creation path of the programming element is recorded. For example, as shown in FIG. 4B, starting from a main graph 40 (root node) of graphical programming, programming elements (subnodes) presented in the first state in graphical programming are recorded level by level, and includes a programming element 41, a programming element 42, a programming element 43, and a programming element 44. The programming element 41 and the programming element 42 correspond to the same target resource 45, and the programming element 43 and the programming element 44 correspond to the same target resource 46. Assuming that an interior of the programming element 42 needs to be entered for editing, there may actually be four paths, and all programming elements presented in the first state in the paths need to be recorded before positioning can be performed. Therefore, a tree diagram may be maintained to record the creation path of the programming element to position the programming element.

With the technical solution of this embodiment of the present disclosure, in response to the identifier trigger operation applied to the element identifiers in the navigation bar, a target programming element to be searched for can be positioned visually and quickly based on the element identifiers in the navigation bar, and the operation is simple and convenient. Furthermore, the programming elements displayed in the visual programming interface are used as initial programming elements, based on a creation path of the initial programming elements in the visual programming interface, the target programming element corresponding to the element identifiers is searched for level by level, and a search path can be optimized with reference to current display information in the visual programming interface, so as to quickly position the target programming element to be searched for.

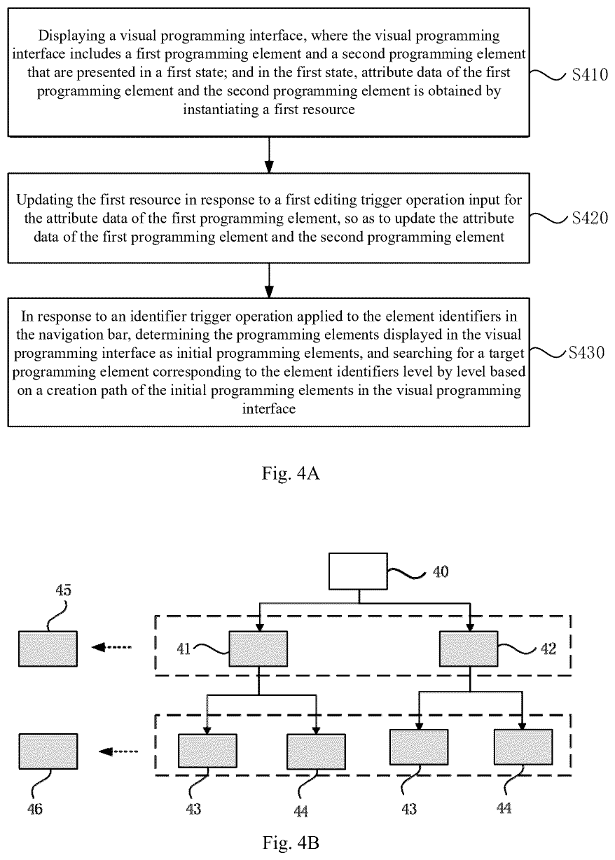

FIG. 5 is a structural schematic diagram of a visual programming apparatus according to an embodiment of the present disclosure. As shown in FIG. 5, the visual programming apparatus includes a programming interface display module 510 and an element linkage editing module 520. The programming interface display module is configured to display a visual programming interface, where the visual programming interface includes a first programming element and a second programming element that are presented in a first state; and in the first state, attribute data of the first programming element and the second programming element is obtained by instantiating a first resource. The element linkage editing module is configured to update the first resource in response to a first editing trigger operation input for the attribute data of the first programming element, so as to update the attribute data of the first programming element and the second programming element.

According to the technical solutions of this embodiment of the present disclosure, firstly, the visual programming interface is displayed for programming interaction. Since the visual programming interface includes the first programming element and the second programming element that are presented in the first state, and in the first state, the attribute data of the first programming element and the second programming element is obtained by instantiating the first resource, that is, the first programming element and the second programming element can be presented in an instantiated state, thereby enriching a presentation state of programming elements in the visual programming interface. Then, since the first programming element and the second programming element correspond to the same target resource, the element linkage editing module updates the first resource in response to the first editing trigger operation input for the attribute data of the first programming element, so that the attribute data of the first programming element and the second programming element can be updated in batches, thereby solving the technical problem of low programming efficiency caused by the need to edit programming elements one by one, improving efficiency of visual programming, and improving visual programming experience of a user.

On the basis of the above optional technical solutions, optionally, the attribute data includes at least one of an element type, an element identifier, a port identifier of an element port, an internal variable, data of included subelements, and connection line data between the subelements of the first programming element and the second programming element.

On the basis of the above optional technical solutions, optionally, the visual programming apparatus further includes an input-output editing module. The input-output editing module is configured to update, after the displaying a visual programming interface, input data and/or output data of the first programming element in response to a second editing trigger operation input for the first programming element, where the input data and/or the output data is associated with an element port of the first programming element and connection line data of the element port.

On the basis of the above optional technical solutions, optionally, the visual programming apparatus further includes a presentation state switching module. The presentation state switching module is configured to switch, after the displaying a visual programming interface, the first programming element and/or the second programming element from the first state to a second state in response to a state switching trigger operation for the first programming element and/or the second programming element, where in the second state, the attribute data of the first programming element and the second programming element is element private data.

On the basis of the above optional technical solutions, optionally, the visual programming apparatus further includes an element parsing trigger module, a parsing data determining module, and a script file generation module. The element parsing trigger module is configured to acquire a plurality of programming elements to be parsed in the visual programming interface in response to an element parsing trigger operation after the displaying a visual programming interface. The parsing data determining module is configured to parse the programming elements to be parsed respectively based on a presentation state of each of the programming elements to be parsed, to obtain element parsing data of the programming elements to be parsed, where the presentation state includes at least the first state. The script file generation module is configured to generate a target script file the element parsing data of the programming elements to be parsed and an association relationship between the plurality of programming elements to be parsed.

On the basis of the above optional technical solutions, optionally, the parsing data determining module is specifically configured to, when the programming elements to be parsed are presented in the first state, obtain the element parsing data by instantiating a target resource of the programming elements to be parsed; and/or, when the programming elements to be parsed are presented in a second state, expand the programming elements to be parsed to obtain the element parsing data of the programming elements to be parsed.

On the basis of the above optional technical solutions, optionally, the visual programming apparatus further includes a creation path display module, where the creation path display module is configured to display, for a third programming element in a visible state in the visual programming interface, a creation path of the third programming element in the visual programming interface after the displaying a visual programming interface.

On the basis of the above optional technical solutions, optionally, the visual programming interface includes a navigation bar, and the navigation bar is used to display element identifiers of programming elements that have been created in the visual programming interface; a presentation mode of a plurality of the element identifiers in the navigation bar is associated with a presentation state of the programming elements; and the presentation state includes at least the first state.

On the basis of the above optional technical solutions, optionally, the visual programming apparatus further includes a programming element searching module. After the displaying a visual programming interface, the programming element searching module is configured to, in response to an identifier trigger operation applied to the element identifiers in the navigation bar, determining the programming elements displayed in the visual programming interface as initial programming elements, and searching for a target programming element corresponding to the element identifiers level by level based on a creation path of the initial programming elements in the visual programming interface.

On the basis of the above optional technical solutions, optionally, the visual programming interface includes a fourth programming element; and a fifth programming element is nested in the fourth programming element, and attribute data of the fifth programming element is obtained by instantiating a second resource.

The visual programming apparatus according to this embodiment of the present disclosure can perform the visual programming method according to any embodiment of the present disclosure and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

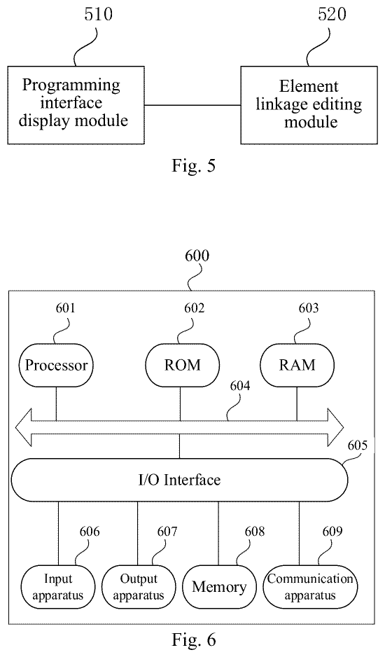

FIG. 6 is a structural schematic diagram of an electronic device according to an embodiment of the present disclosure. Reference is made to FIG. 6 below, which is a structural schematic diagram of an electronic device (such as a terminal device or a server in FIG. 6) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processor (e.g., a central processing unit or a graphics processing unit) 601 that may perform a variety of appropriate actions and processing in accordance with a program stored in a read-only memory (ROM) 602 or a program loaded from a memory 508 into a random access memory (RAM) 603. The RAM 603 further stores various programs and data required for operations of the electronic device 600. The processor 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the memory 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the memory 608, or installed from the ROM 602. When the computer program is executed by the processor 601, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the visual programming method according to the above embodiments belong to the same inventive concept. For the technical details not described in detail in this embodiment, reference may made to the above embodiments, and this embodiment and the above embodiments have the same beneficial effects.

An embodiment of the present disclosure provides a computer storage medium storing a computer program thereon. When the program is executed by a processor, the processor implements the visual programming method according to the above embodiment.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: display a visual programming interface, where the visual programming interface includes a first programming element and a second programming element that are presented in a first state; and in the first state, attribute data of the first programming element and the second programming element is obtained by instantiating a first resource; and update the first resource in response to a first editing trigger operation input for the attribute data of the first programming element, so as to update the attribute data of the first programming element and the second programming element.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases. For example, a programming interface display module may alternatively be described as “a module for obtaining a first programming element and a second programming element”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides a visual programming method, including: displaying a visual programming interface, where the visual programming interface includes a first programming element and a second programming element that are presented in a first state; and in the first state, attribute data of the first programming element and the second programming element is obtained by instantiating a first resource; and updating the first resource in response to a first editing trigger operation input for the attribute data of the first programming element, so as to update the attribute data of the first programming element and the second programming element.

According to one or more embodiments of the present disclosure, Example 2 provides the method of Example 1, optionally, the attribute data includes at least one of an element type, an element identifier, a port identifier of an element port, an internal variable, data of included subelements, and connection line data between the subelements of the first programming element and the second programming element.

According to one or more embodiments of the present disclosure, Example 3 provides the method of Example 1, optionally, after the displaying a visual programming interface, the method further includes: updating input data and/or output data of the first programming element in response to a second editing trigger operation input for the first programming element, where the input data and/or the output data is associated with an element port of the first programming element and connection line data of the element port.

According to one or more embodiments of the present disclosure, Example 4 provides the method of Example 1, optionally, after the displaying a visual programming interface, the method further includes: switching the first programming element and/or the second programming element from the first state to a second state in response to a state switching trigger operation for the first programming element and/or the second programming element, where in the second state, the attribute data of the first programming element and the second programming element is element private data.

According to one or more embodiments of the present disclosure, Example 5 provides the method of Example 1, optionally, after the displaying a visual programming interface, the method further includes: acquiring a plurality of programming elements to be parsed in the visual programming interface in response to an element parsing trigger operation; parsing the programming elements to be parsed respectively based on a presentation state of each of the programming elements to be parsed, to obtain element parsing data of the programming elements to be parsed, where the presentation state includes at least the first state; and generating a target script file the element parsing data of the programming elements to be parsed and an association relationship between the plurality of programming elements to be parsed.

According to one or more embodiments of the present disclosure, Example 6 provides the method of Example 5, optionally, the parsing the programming elements to be parsed respectively based on a presentation state of each of the programming elements to be parsed, to obtain element parsing data of the programming elements to be parsed, includes: when the programming elements to be parsed are presented in the first state, obtaining the element parsing data by instantiating a target resource of the programming elements to be parsed; and/or expanding, when the programming elements to be parsed are presented in a second state, the programming elements to be parsed to obtain the element parsing data of the programming elements to be parsed.

According to one or more embodiments of the present disclosure, Example 7 provides the method of Example 1, optionally, after the displaying a visual programming interface, the method further includes: displaying, for a third programming element in a visible state in the visual programming interface, a creation path of the third programming element in the visual programming interface.

According to one or more embodiments of the present disclosure, Example 8 provides the method of Example 1, optionally, the visual programming interface includes a navigation bar, and the navigation bar is used to display element identifiers of programming elements that have been created in the visual programming interface; a presentation mode of a plurality of the element identifiers in the navigation bar is associated with a presentation state of the programming elements; and the presentation state includes at least the first state.

According to one or more embodiments of the present disclosure, Example 9 provides the method of Example 8, optionally, after the displaying a visual programming interface, the method further includes: in response to an identifier trigger operation applied to the element identifiers in the navigation bar, determining the programming elements displayed in the visual programming interface as initial programming elements, and searching for a target programming element corresponding to the element identifiers level by level based on a creation path of the initial programming elements in the visual programming interface.

According to one or more embodiments of the present disclosure, Example 10 provides the method of Example 1, optionally, the visual programming interface includes a fourth programming element; and a fifth programming element is nested in the fourth programming element, and attribute data of the fifth programming element is obtained by instantiating a second resource.

According to one or more embodiments of the present disclosure, a visual programming apparatus is provided, and includes a programming interface display module and an element linkage editing module. The programming interface display module is configured to display a visual programming interface, where the visual programming interface includes a first programming element and a second programming element that are presented in a first state; and in the first state, attribute data of the first programming element and the second programming element is obtained by instantiating a first resource.

The element linkage editing module is configured to update the first resource in response to a first editing trigger operation input for the attribute data of the first programming element, so as to update the attribute data of the first programming element and the second programming element.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A visual programming method, comprising:
displaying a visual programming interface, wherein the visual programming interface comprises a first programming element and a second programming element that are presented in a first state, and in the first state, attribute data of the first programming element and the second programming element is obtained by instantiating a first resource; and
updating the first resource in response to a first editing trigger operation input for the attribute data of the first programming element, so as to update the attribute data of the first programming element and the second programming element.

2. The visual programming method according to claim 1, wherein the attribute data comprises at least one of an element type, an element identifier, a port identifier of an element port, an internal variable, data of comprised subelements, and connection line data between the subelements of the first programming element and the second programming element.

3. The visual programming method according to claim 1, wherein after the displaying the visual programming interface, the visual programming method further comprises:
updating input data and/or output data of the first programming element in response to a second editing trigger operation input for the first programming element, wherein the input data and/or the output data is associated with an element port of the first programming element and connection line data of the element port.

4. The visual programming method according to claim 1, wherein after the displaying the visual programming interface, the visual programming method further comprises:
switching the first programming element and/or the second programming element from the first state to a second state in response to a state switching trigger operation for the first programming element and/or the second programming element, wherein in the second state, the attribute data of the first programming element and the second programming element is element private data.

5. The visual programming method according to claim 1, wherein after the displaying the visual programming interface, the visual programming method further comprises:
acquiring a plurality of programming elements to be parsed in the visual programming interface in response to an element parsing trigger operation;
parsing the programming elements to be parsed respectively based on a presentation state of each of the programming elements to be parsed, to obtain element parsing data of the programming elements to be parsed, wherein the presentation state comprises at least the first state; and
generating a target script file based on the element parsing data of the programming elements to be parsed and an association relationship between the plurality of programming elements to be parsed.

6. The visual programming method according to claim 5, wherein the parsing the programming elements to be parsed respectively based on the presentation state of each of the programming elements to be parsed, to obtain the element parsing data of the programming elements to be parsed, comprises:
obtaining, when the programming elements to be parsed are presented in the first state, the element parsing data by instantiating a target resource of the programming elements to be parsed; and/or
expanding, when the programming elements to be parsed are presented in a second state, the programming elements to be parsed to obtain the element parsing data of the programming elements to be parsed.

7. The visual programming method according to claim 1, wherein after the displaying the visual programming interface, the visual programming method further comprises:
displaying, for a third programming element in a visible state in the visual programming interface, a creation path of the third programming element in the visual programming interface.

8. The visual programming method according to claim 1, wherein the visual programming interface comprises a navigation bar, and the navigation bar is used to display element identifiers of programming elements that have been created in the visual programming interface; a presentation mode of a plurality of the element identifiers in the navigation bar is associated with a presentation state of the programming elements; and the presentation state comprises at least the first state.

9. The visual programming method according to claim 8, wherein after the displaying the visual programming interface, the visual programming method further comprises:
in response to an identifier trigger operation applied to the element identifiers in the navigation bar, determining the programming elements displayed in the visual programming interface as initial programming elements, and searching for a target programming element corresponding to the element identifiers level by level based on a creation path of the initial programming elements in the visual programming interface.

10. The visual programming method according to claim 1, wherein the visual programming interface comprises a fourth programming element, a fifth programming element is nested in the fourth programming element, and attribute data of the fifth programming element is obtained by instantiating a second resource.

11. An electronic device, comprising:
one or more processors; and
a memory, configured to store one or more programs,
wherein when the one or more programs are executed by the one or more processors, the one or more processors is caused to implement a visual programming method, and the visual programming method comprises:
displaying a visual programming interface, wherein the visual programming interface comprises a first programming element and a second programming element that are presented in a first state, and in the first state, attribute data of the first programming element and the second programming element is obtained by instantiating a first resource; and
updating the first resource in response to a first editing trigger operation input for the attribute data of the first programming element, so as to update the attribute data of the first programming element and the second programming element.

12. A non-transitory storage medium, comprising computer-executable instructions, wherein when the computer-executable instructions are executed by a computer processor, the computer-executable instructions are used to perform a visual programming method, and the visual programming method comprises:
displaying a visual programming interface, wherein the visual programming interface comprises a first programming element and a second programming element that are presented in a first state, and in the first state, attribute data of the first programming element and the second programming element is obtained by instantiating a first resource; and
updating the first resource in response to a first editing trigger operation input for the attribute data of the first programming element, so as to update the attribute data of the first programming element and the second programming element.

13. The electronic device according to claim 11, wherein the attribute data comprises at least one of an element type, an element identifier, a port identifier of an element port, an internal variable, data of comprised subelements, and connection line data between the subelements of the first programming element and the second programming element.

14. The electronic device according to claim 11, wherein after the displaying the visual programming interface, the visual programming method further comprises:
updating input data and/or output data of the first programming element in response to a second editing trigger operation input for the first programming element, wherein the input data and/or the output data is associated with an element port of the first programming element and connection line data of the element port.

15. The electronic device according to claim 11, wherein after the displaying the visual programming interface, the visual programming method further comprises:
switching the first programming element and/or the second programming element from the first state to a second state in response to a state switching trigger operation for the first programming element and/or the second programming element, wherein in the second state, the attribute data of the first programming element and the second programming element is element private data.

16. The electronic device according to claim 11, wherein after the displaying the visual programming interface, the visual programming method further comprises:
acquiring a plurality of programming elements to be parsed in the visual programming interface in response to an element parsing trigger operation;
parsing the programming elements to be parsed respectively based on a presentation state of each of the programming elements to be parsed, to obtain element parsing data of the programming elements to be parsed, wherein the presentation state comprises at least the first state; and
generating a target script file based on the element parsing data of the programming elements to be parsed and an association relationship between the plurality of programming elements to be parsed.

17. The electronic device according to claim 16, wherein the parsing the programming elements to be parsed respectively based on the presentation state of each of the programming elements to be parsed, to obtain the element parsing data of the programming elements to be parsed, comprises:
obtaining, when the programming elements to be parsed are presented in the first state, the element parsing data by instantiating a target resource of the programming elements to be parsed; and/or
expanding, when the programming elements to be parsed are presented in a second state, the programming elements to be parsed to obtain the element parsing data of the programming elements to be parsed.

18. The electronic device according to claim 11, wherein after the displaying the visual programming interface, the visual programming method further comprises:
displaying, for a third programming element in a visible state in the visual programming interface, a creation path of the third programming element in the visual programming interface.

19. The electronic device according to claim 11, wherein the visual programming interface comprises a navigation bar, and the navigation bar is used to display element identifiers of programming elements that have been created in the visual programming interface; a presentation mode of a plurality of the element identifiers in the navigation bar is associated with a presentation state of the programming elements; and the presentation state comprises at least the first state.

20. The electronic device according to claim 19, wherein after the displaying a visual programming interface, the visual programming method further comprises:
in response to an identifier trigger operation applied to the element identifiers in the navigation bar, determining the programming elements displayed in the visual programming interface as initial programming elements, and searching for a target programming element corresponding to the element identifiers level by level based on a creation path of the initial programming elements in the visual programming interface.
